(19) United States
(12) Patent Application Publication
(10) Pub. No.: US 2012/0282042 A1
(43) Pub. Date: Nov. 8, 2012

(54) THREE-DIMENSIONAL NETTED VEGETATION BLANKET WITH UPRIGHT LOOPS

(76) Inventor: Chung-Hsiung WANG, Yang Mei Town (TW)

(21) Appl. No.: 13/100,062

(22) Filed: May 3, 2011

(51) Int. Cl. A01C 14/00

(52) U.S. Cl. 405/302.7

(57) ABSTRACT

A three-dimensional netted vegetation blanket with upright loops is manufactured by mechanically weaving a plurality of longitudinal, transverse, and loop-forming threads. The transverse threads are woven into a plurality of horizontal net bodies having a predetermined thickness and presenting a plurality of interlocked double-ply rings. The longitudinal threads are twisted threads having a predetermined strength, and are extended through the horizontal net bodies. The loop-forming threads are upward and downward extended through the interlocked rings of the horizontal net bodies to form a plurality of upright loops over any two parallelly adjacent horizontal net bodies, so as to give the netted vegetation blanket an enhanced structural strength and provide a 3D growing space for vegetation seeds. The 3D netted vegetation blanket has high void ratio to advantageously grow seeds and support seedlings, and thereby provides good effect in soil and water conservation as well as vegetation engineering works.

### FIELD OF THE INVENTION

The present invention relates to a three-dimensional (3D) netted vegetation blanket, and more particularly to a 3D netted vegetation blanket with upright loops that has enhanced structural strength, provides a 3D growing space for vegetation seeds, and has high void ratio to support seedlings, and can therefore be advantageously used in slope protection, soil and water conservation as well as other vegetation engineering works.

### BACKGROUND OF THE INVENTION

According to the conventional ways for slope protection, soil and water conservation, and vegetation engineering works, soil is first spread over the slope to form a layer of top soil, vegetation seeds are then sowed or sprayed over the top soil before a netted vegetation blanket is spread over the vegetation seeds. Alternatively, a layer of soil can be further spread over the netted vegetation blanket. The netted vegetation blanket is provided mainly to protect plants, grass seeds and soil on slopes, lest the soil and the vegetation seeds and seedling should be washed off due to soil erosion caused by rainwater and have adverse influence on the slope protection, soil and water conservation, and other vegetation engineering works.

FIG. 1 is a schematic view of a conventional vegetation blanket which includes a grid 10 forming an upper side thereof, and a fiber-formed mat 15 covered by the grid 10. The fiber-formed mat 15 is formed of natural fibers, such as rice stalks, wheat stalks, hemp fibers, and the like. The conventional vegetation blanket with the above structure has the following disadvantages in use:

(1) The fiber-formed mat 15 has a relatively low void ratio and would therefore limit the growth of vegetation seeds, resulting in poor effect in vegetation practices.

(2) The grid 10 and the fiber-formed mat 15 are not 3D structures and fail to effectively hold the vegetation seeds thereto. In the case of heavy rain during the vegetation process, the seeds below the vegetation blanket are easily flushed off from the soil to result in poor vegetation effect.

(3) The fiber-formed mat 15 is formed of natural fibers, which are good foods for some insects and parasites. As a result, the fiber-formed mat 15 is easily become moth-eaten or worm-eaten to damage the overall structure of the vegetation blanket.

It is therefore necessary to overcome the above disadvantages in the conventional vegetation blanket.

### SUMMARY OF THE INVENTION

A primary object of the present invention is to provide a 3D netted vegetation blanket with upright loops, which is manufactured via interlacing multi-layer weaving to have a three-dimensional structure and high void ratio, and is therefore suitable for growing vegetation seeds and supporting seedlings when being used in slope protection, soil and water conservation, and vegetation engineering works.

Another object of the present invention is to provide a 3D netted vegetation blanket that has enhanced structural strength and can be conveniently transported and easily installed when being used in slope protection, soil and water conservation, and vegetation engineering works.

To achieve the above and other objects, the 3D netted vegetation blanket with upright loops according to the present invention is manufactured by mechanically weaving a plurality of longitudinal, transverse, and loop-forming threads. Through continuous interlacing and multi-layer weaving, the transverse threads are woven into a plurality of horizontal net bodies having a predetermined thickness and presenting a plurality of interlocked double-ply rings. The longitudinal threads are twisted threads having a predetermined strength, and are extended through the horizontal net bodies. The loop-forming threads are upward and downward extended through the interlocked rings of the horizontal net bodies to form a plurality of upright loops over any two parallelly adjacent horizontal net bodies. With these arrangements, the 3D netted vegetation blanket has an enhanced structural strength and provides a 3D growing space for vegetation seeds. The 3D netted vegetation blanket also has high void ratio to advantageously support seedlings and provide good effect in soil and water conservation as well as vegetation engineering works.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a schematic view of a conventional vegetation blanket;

FIG. 2 is a perspective view of a 3D netted vegetation blanket with upright loops according to the present invention;

FIG. 3 is an enlarged view of the circled area of FIG. 2;

FIG. 4 is a top view of the 3D netted vegetation blanket with upright loops according to the present invention; and

FIG. 5 is a side view showing the use of the 3D netted vegetation blanket with upright loops according to the present invention.

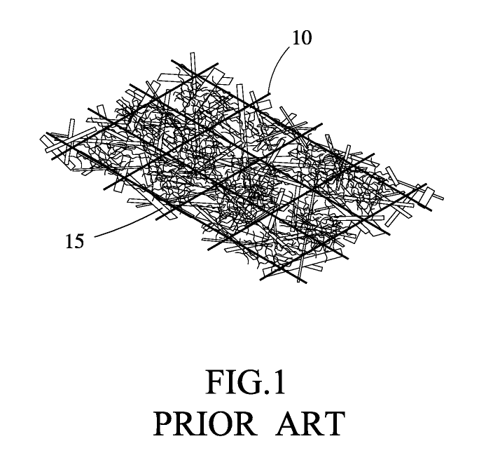

### DETAILED DESCRIPTION OF THE PREFERRED EMBODIMENTS

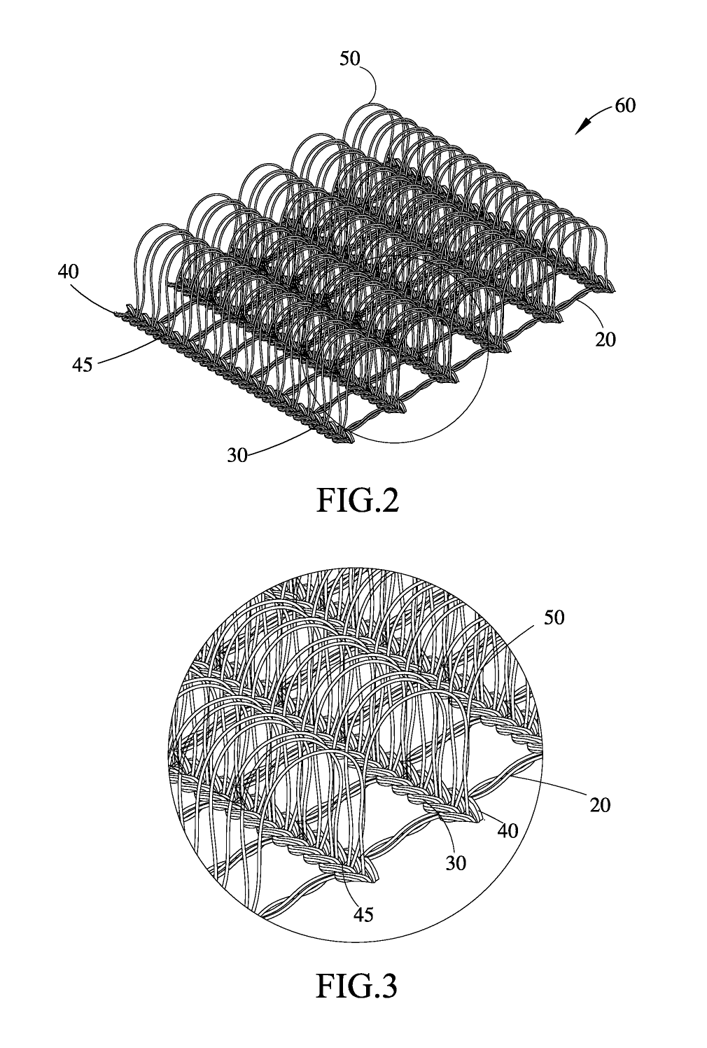

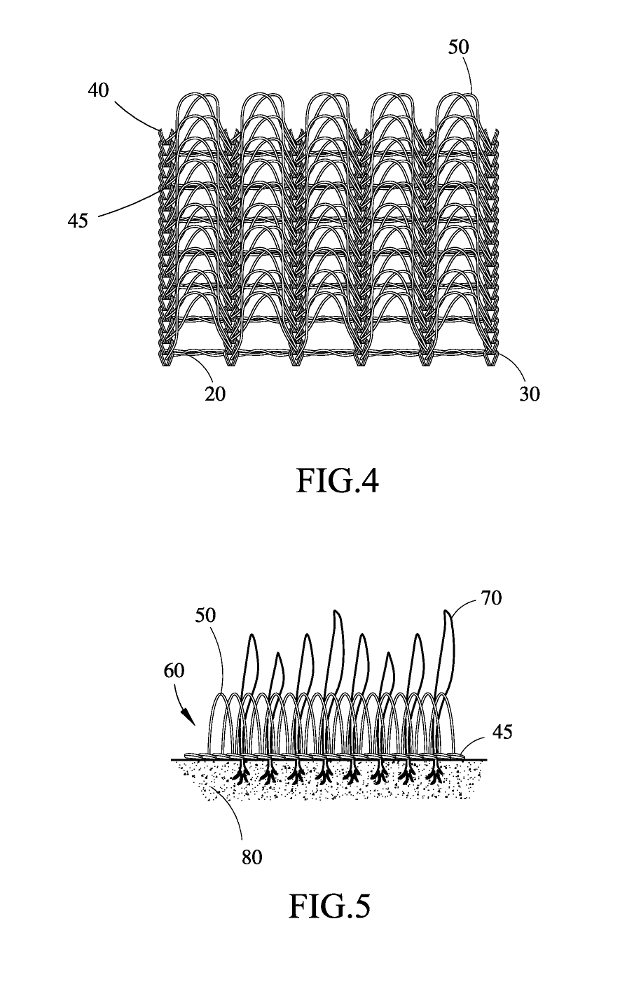

Please refer to FIGS. 2, 3 and 4 that are perspective, partially enlarged, and top views, respectively, of a three-dimensional (3D) netted vegetation blanket with upright loops according to the present invention. For the purpose of conciseness, the present invention is also briefly referred to as “the 3D netted vegetation blanket” and is generally denoted by reference numeral 60 herein. As shown, the 3D netted vegetation blanket 60 is manufactured by interlacing a plurality of longitudinal threads 20 and a plurality of transverse threads 40, so that the transverse threads 40 are extended through by the longitudinal threads 20. Each of the longitudinal threads 20 includes two or more twisted threads. The transverse threads 40 are first woven into a plurality of complicated and interlocked double-ply rings 45 via continuous interlacing multi-layer weaving on a corresponding machine, so as to provide a plurality of horizontal net bodies 30 having a predetermined thickness. That is, the horizontal net bodies 30 are respectively a three-dimensional structure presenting a plurality of interlocked double-ply rings 45, and are parallelly spaced from one another. Further, a plurality of loop-forming threads 50 are respectively upward and downward extended through the interlocked double-ply rings 45 in a wave form to sequentially extend across the horizontal net bodies 30 in a direction the same as the longitudinal threads 20 and thereby form a plurality of upright loops over any two adjacent horizontal net bodies 30. The upright loops formed by the loop-forming threads 50 give the 3D netted vegetation blanket 60 a further enhanced structural strength and provide a 3D growing space for vegetation seeds.

FIG. 5 is a side view showing the use of the 3D netted vegetation blanket 60 of the present invention to grow plants. As shown, after the 3D netted vegetation blanket 60 is spread over a layer of top soil 80, vegetation seeds are sowed and base fertilizer is applied over the 3D netted vegetation blanket 60. Since the interlocked double-ply rings 45 are horizontally extended in a direction perpendicular to the longitudinal threads 20, and the upright loops 50 are vertically extended also in a direction perpendicular to the longitudinal threads 20, it is possible to effectively prevent the sowed seeds from easily running off the top soil 80. Seedlings 70 that pass through the interlocked double-ply rings 45 and grow upward can obtain sufficient soil nutrient while being protectively supported by the upright loops 50. Further, the 3D netted vegetation blanket 60 of the present invention has a high void ratio and accordingly provides an advantageous 3D space for the seedlings 70 to stretch and grow. Roots of the seedlings 70 naturally interlace with the longitudinal and transverse threads 20, 40 of the 3D netted vegetation blanket 60 while firmly extend downward into the top soil 80, producing good effect in soil erosion prevention to protect the seedlings 70 and soil 80 against running off caused by rainwater. Therefore, the 3D netted vegetation blanket with upright loops according to the present invention provides excellent effects in vegetation engineering as well as soil and water conservation.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A three-dimensional (3D) netted vegetation blanket with upright loops, comprising a plurality of interlaced longitudinal threads, transverse threads, and loop-forming threads; the transverse threads being mechanically woven to provide a plurality of horizontal net bodies having a predetermined thickness and presenting a plurality of interlocked double-ply rings; the horizontal net bodies being parallelly arranged to space from one another; and the loop-forming threads being extended through the interlocked double-ply rings to sequentially extend across the horizontal net bodies in a direction the same as the longitudinal threads and thereby form a plurality of upright loops over the horizontal net bodies; whereby the upright loops formed by the loop-forming threads give the netted vegetation blanket an enhanced structural strength and provide a 3D growing space for vegetation seeds.

2. The 3D netted vegetation blanket with upright loops as claimed in claim 1, wherein each of the longitudinal threads includes two or more twisted threads.

3. The 3D netted vegetation blanket with upright loops as claimed in claim 1, wherein each of the horizontal net bodies is formed by interlacing multi-layer weaving.

4. The 3D netted vegetation blanket with upright loops as claimed in claim 1, wherein each of the horizontal net bodies presents a plurality of complicated interlocked rings.

5. The 3D netted vegetation blanket with upright loops as claimed in claim 1, wherein the interlocked double-ply rings presented on the horizontal net bodies provide a three-dimensional structure having an upper and a lower layer.

6. The 3D netted vegetation blanket with upright loops as claimed in claim 1, wherein the loop-forming threads are respectively upward and downward extended through the interlocked rings of the horizontal net bodies in a wave form.

7. The 3D netted vegetation blanket with upright loops as claimed in claim 1, wherein the loop-forming threads form the upright loops between any two adjacent horizontal net bodies.
